(19) United States
(12) Patent Application Publication
(10) Pub. No.: US 2019/0132352 A1
(43) Pub. Date: May 2, 2019

(54) NEARLINE CLUSTERING AND PROPAGATION OF ENTITY ATTRIBUTES IN ANTI-ABUSE INFRASTRUCTURES

(71) Applicant: Microsoft Technology Licensing, LLC, Redmond, WA (US)

(72) Inventors: Jie Zhang, Sunnyvale, CA (US); Grace W. Tang, Los Altos, CA (US); Yuefeng Li, Santa Clara, CA (US); Jenelle Bray, Sunnyvale, CA (US); Theodore H. Hwa, Cupertino, CA (US); Xi Sun, Sunnyvale, CA (US); Sahil Handa, Sunnyvale, CA (US)

(73) Assignee: Microsoft Technology Licensing, LLC, Redmond, WA (US)

(21) Appl. No.: 15/799,685

(22) Filed: Oct. 31, 2017

(51) Int. Cl. H04L 29/06

(52) U.S. Cl. CPC H04L 63/1441; G06Q 10/1053; H04L 63/1483

(57) ABSTRACT

The disclosed embodiments provide a system for processing actions with a service. During operation, the system obtains a first attribute associated with a first cluster of entities identified as malicious to a service. Next, the system matches the first attribute to a second attribute of an entity in the first cluster. The system then uses the second attribute to identify a second cluster of entities as malicious to the service. Finally, the system uses cluster scores for identifying the first and second clusters of entities as malicious to the service to output responses to actions associated with entities in the first and second clusters of entities.

### BACKGROUND

### Field

The disclosed embodiments relate to anti-abuse infrastructures. More specifically, the disclosed embodiments relate to nearline clustering and propagation of entity attributes in anti-abuse infrastructures.

### Related Art

Incident response techniques are commonly used to address and manage attacks such as security breaches, fake user accounts, spamming, phishing, account takeovers, scraping, and/or other types of malicious or undesired user activity. For example, an organization may use an incident response team and/or incident response system to identify, respond to, escalate, contain, and/or recover from security incidents. The organization may also analyze past incidents to obtain insights for responding to and/or preventing similar types of activity in the future. Consequently, the negative impact of security incidents may be reduced by quickly and effectively detecting, adapting to, and responding to malicious activity within Information Technology (IT) infrastructures.

### BRIEF DESCRIPTION OF THE FIGURES

FIG. 1 shows a schematic of a system in accordance with the disclosed embodiments.

FIG. 2 shows a system for processing actions with a service in accordance with the disclosed embodiments.

FIG. 3 shows a flowchart illustrating the processing of actions with a service in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

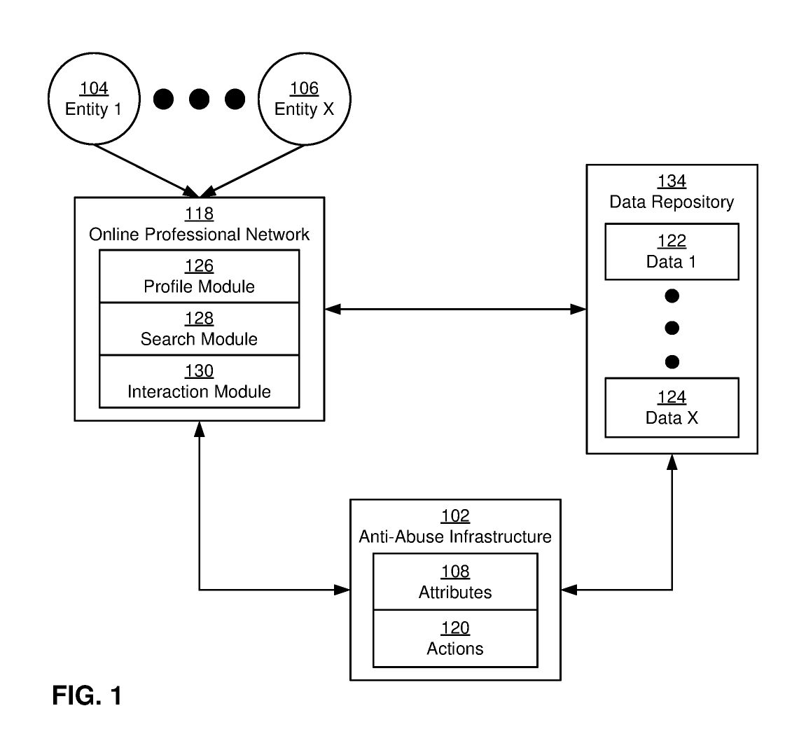

The disclosed embodiments provide a method, apparatus, and system for detecting and managing malicious activity with a service. As shown in FIG. 1, the service may be provided by or associated with an online professional network 118 or other community of users, which is used by a set of entities (e.g., entity 1 104, entity x 106) to interact with one another in a professional, business and/or social context.

The entities may include users that use online professional network 118 to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action. The entities may further include guests that are not registered members of the online professional network and thus have restricted access to the online professional network.

Entities that are registered members of online professional network 118 may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

Entities that are registered members, and guests, may use a search module 128 to search online professional network 118 for people, companies, jobs, and/or other job- or business-related information. For example, the entities may input one or more keywords into a search bar to find profiles, job postings, articles, advertisements, and/or other information that includes and/or otherwise matches the keyword(s). The entities may additionally use an “Advanced Search” feature of online professional network 118 to search for profiles, jobs, and/or other information by categories such as first name, last name, title, company, school, location, interests, relationship, industry, groups, salary, experience level, etc.

Entities that are registered members of online professional network 118 may also use an interaction module 130 to interact with other entities in online professional network 118. For example, interaction module 130 may allow an entity to add other entities as connections, follow other entities, send and receive messages with other entities, join groups, and/or interact with (e.g., create, share, re-share, like, and/or comment on) posts from other entities. Interaction module 130 may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be logged and stored in a database, data warehouse, cloud storage, and/or other data-storage mechanism providing data repository 134.

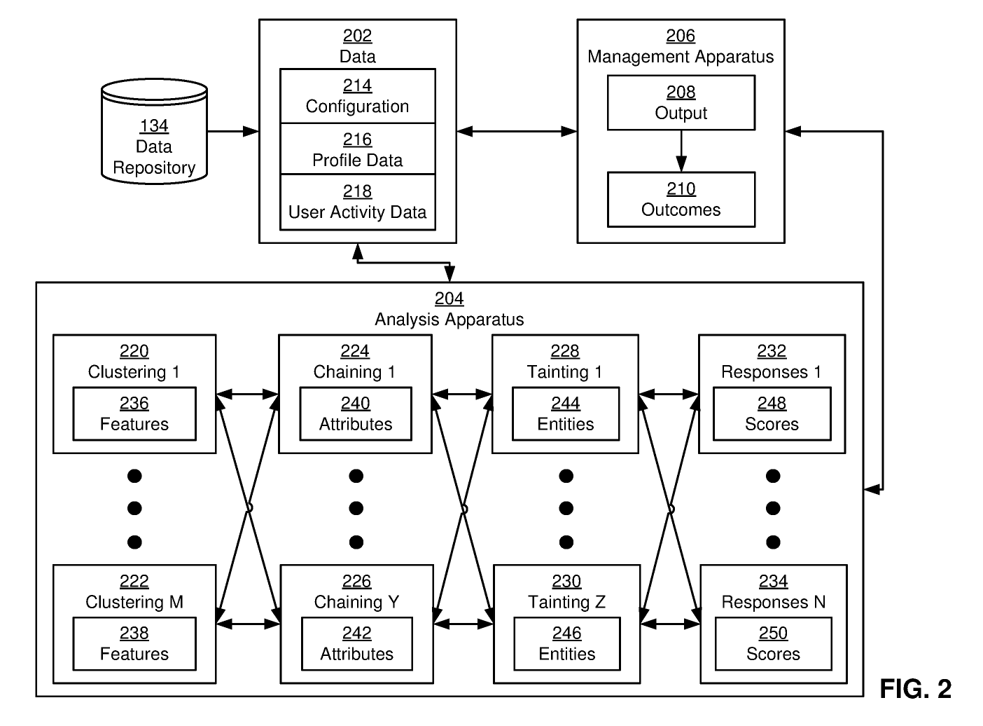

In turn, the data may be analyzed by an anti-abuse infrastructure 102 in a real-time, nearline, and/or offline basis to detect and respond to attacks such as security breaches, fake user accounts, account takeovers, spamming, phishing, scraping, and/or other types of malicious or undesired user activity with online professional network 118. As described in further detail below with respect to FIG. 2, anti-abuse infrastructure 102 may identify attributes 108 associated with clusters of malicious entities in online professional network 118 and/or services associated with online professional network 118. For example, anti-abuse infrastructure 102 may use a statistical model to identify clusters and/or groupings of entities that are likely to be malicious based on attributes 108 shared by the entities. Such cluster identification may be performed on a real-time, nearline, and/or offline basis.

Anti-abuse infrastructure 102 may then propagate reputations associated with attributes 108 across different clusters or groupings of the entities and/or use attributes 108 to respond to actions 120 by the entities. For example, anti-abuse infrastructure 102 may use one attribute associated with a cluster of malicious entities to identify additional entities that share the attribute and flag the additional entities as malicious or possibly malicious. In turn, other attributes of the additional entities may then be used to identify more potentially malicious entities in online professional network 118. In turn, anti-abuse infrastructure 102 may respond to actions 120 by the flagged entities by accepting, delaying, redirecting, and/or blocking actions 120; flagging actions 120 and/or the entities for manual review; whitelisting or blacklisting the entities; and/or presenting challenges related to actions 120.

FIG. 2 shows a system for processing actions with a service, such as anti-abuse infrastructure 102 of FIG. 1, in accordance with the disclosed embodiments. The system includes an analysis apparatus 204 and a management apparatus 206, which interact with one another and use data repository 134 to manage security incidents with the service. For example, the system of FIG. 2 may be used to identify and/or respond to potentially malicious actions by entities 244-246 within a social network, such as online professional network 118 of FIG. 1. The system may also, or instead, be used to process actions from entities 244-246 with other network-based services, such as other types of social networks, online storage systems, e-commerce platforms, web applications, email services, messaging services, financial transaction services, and/or streaming media services.

As mentioned above, data repository 134 and/or another primary data store may be queried for data 202 that includes profile data 216 for members of the social network (e.g., online professional network 118 of FIG. 1), as well as user activity data 218 that logs the activity of the members and/or guests within and/or outside the social network. Profile data 216 may include data associated with member profiles in the social network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), personal (e.g., first name, last name, email address, phone number, postal address, etc.), and/or educational (e.g., degree, university attended, certifications, publications) attributes. Profile data 216 may also include a set of groups to which the user belongs, the user's contacts and/or connections, and/or other data related to the user's interaction with the social network.

Attributes of the members may be matched to a number of member segments, with each member segment containing a group of members that share one or more common attributes. For example, member segments in the social network may be defined to include members with the same industry, location, profession, skills, and/or language.

Connection information in profile data 216 may additionally be combined into a graph, with nodes in the graph representing entities 244-246 (e.g., users, schools, companies, locations, etc.) in the social network. In turn, edges between the nodes in the graph may represent relationships between the corresponding entities 244-246, such as connections between pairs of members, education of members at schools, employment of members at companies, following of a member or company by another member, business relationships and/or partnerships between organizations, and/or residence of members at locations.

Profile data 216 may also, or instead, include user data for user accounts with various network-based services. For example, profile data 216 may include a name, email address, physical address, username, date of birth, gender, and/or other basic demographic information for a user of an e-commerce site.

User activity data 218 may include records of user interactions with the service. For example, the user activity data may identify impressions, clicks, likes, dislikes, shares, hides, comments, posts, updates, conversions, and/or other user interaction with content in a social network. The user activity data may also identify other types of activity, including login attempts, account creation activity, address book imports, connection requests and confirmations, password resets, messages, purchases, job-related activity (e.g., job postings, job searches, job applications, etc.), advertisement-related activity (e.g., creating advertisements, posting advertisements, clicking on advertisements, etc.), and/or interaction with groups or events. Like profile data 216, user activity data 218 may be used to create a graph, with nodes in the graph representing social network members and/or content and edges between pairs of nodes indicating actions taken by members, such as creating or sharing articles or posts, sending messages, connection requests, joining groups, and/or following other entities 244-246.

Analysis apparatus 204 may obtain records of actions with a given service as user activity data 218 from data repository 134. Analysis apparatus 204 may also, or instead, receive events representing the records from real-time and/or nearline sources of user activity data, such as an event stream and/or a monitoring component that executes within the service.

Each record may identify the type of action being performed by an entity. For example, the record may identify the action as a login attempt, account registration, address book upload, password reset, purchase, connection request, messaging, social network interaction (e.g., click, like, dislike, share, hide, comment, post, etc.), and/or other type of user activity monitored by the system.

The record may also be used to retrieve attributes 240-242 associated with the action and/or entity. For example, the attributes may be included in the record and/or in separate records that are linked to the record (e.g., using an identifier for the record). The attributes may include profile data 216, such as a name, email address, phone number, device identifier, location, member identifier, profile completeness, profile photo, pattern of activity, and/or profile fields for the user associated with the action. The attributes may also, or instead, include user input such as messages, search parameters, posts, user preferences, and/or other content submitted by the user with the action. The attributes may further specify a context, such as an Internet Protocol (IP) address, user agent, and/or autonomous system from which the action was received; the time needed to complete the action (e.g., complete a registration form and/or write a message); the time at which the action was received; and/or a state (e.g., IP address reputation, password validity, etc.) associated with the action.

Next, analysis apparatus 204 may process the records and associated data to classify, respond to, and/or escalate security incidents and/or malicious activity represented by the corresponding actions. As mentioned above, such processing may include clustering and propagation of attributes 240-242 associated with entities 244-246 to facilitate the generation of responses (e.g., responses 1 232, responses n 234) to actions by entities 244-246.

As shown in FIG. 2, analysis apparatus 204 may perform clustering (e.g., clustering 1 220, clustering m 222) of entities 244-246 (e.g., users, accounts, organizations, bots, etc.) by features 236-238 associated with the entities. For example, analysis apparatus 204 may group entities 244-246 by one or more attributes 240, such as browser cookie, IP address, user agent, profile data 216 (e.g., profile photo, first name, last name, email address, physical address, username, etc.), user activity data 218 (e.g., sequences of actions, data requested or inputted by the entities, etc.), time of registration with the service, and/or payment information. The grouping may be based on exact matches within a given attribute and/or similarities in values (e.g., ranges or patterns of values) of the attribute.

Analysis apparatus 204 may also, or instead, apply one or more statistical models, such as logistic regression models, support vector machines, and/or random forests, to features 236-238 to determine if clusters of entities 244-246 are malicious or not. For example, analysis apparatus 204 may input a set of features (e.g., features 236-238) associated with cluster of entities 244-246 into a corresponding statistical model to produce a numeric score representing the likelihood that the entire cluster contains malicious entities (e.g., fake or hijacked user accounts). The set of entities 244-246 may be selected to conform to parameters such as a minimum and/or maximum cluster size, a time span of registration with the service (e.g., the last 24 hours, the last week, etc.), and/or clustering criteria (e.g., grouping all accounts by IP address, k-means clustering of the entities, etc.). Additional criteria may optionally be specified to remove entities and/or clusters that are not likely to be malicious, such as entities with accounts registered within a corporate IP space associated with the service.

Features 236-238 may additionally be aggregated prior to inputting features 236-238 into the statistical model(s). For example, raw features (e.g., cookie identifiers, IP addresses, first names, last names, email addresses, profile images, etc.) representing attributes 240-242 of entities 244-246 may be aggregated into one or more distribution features, pattern features, and/or frequency features.

The distribution features may include minimums, maximums, quantiles, means, variances, counts (e.g., total count, count of null values, count of distinct values, etc.), entropies, and/or other summary statistics associated with the raw features. The distribution features may thus capture patterns in the usage of attributes 240-242 within or across groups or clusters of potentially malicious entities 244-246.

The pattern features may include regular expressions and/or other character encodings associated with string-based features such as email addresses or names. As a result, the pattern features may be used to detect corresponding patterns in malicious user or automated activity, such as registering a cluster of fake accounts under a set of automatically generated usernames, names, and/or email addresses.

The frequency features may include frequencies (e.g., counts) of first names, last names, email addresses, and/or other attributes 240-242 across the service and/or outside the service; rankings associated with the frequencies (e.g., the position of an attribute value in a ranking of all attribute values for an attribute in descending order of frequency); and/or logarithms of the frequencies. In turn, the frequency features may facilitate identification of combinations of exceedingly common and/or exceedingly rare attributes 240-242 in the clusters.

As mentioned above, features 236-238 for a given group or cluster of entities 244-246 may be inputted into the corresponding statistical model(s) to generate a numeric cluster score representing the likelihood that entities 244-246 in the cluster are malicious. A threshold may then be applied to the cluster score to classify the cluster as malicious or non-malicious. Additional thresholds may optionally be used to classify the cluster with respect to different levels of risk or severity associated with malicious entities 244-246.

In turn, attributes 240-242 associated with clusters identified as malicious by analysis apparatus 204 may be used by management apparatus 206 to generate output 208 containing responses (e.g., responses 1 232, responses n 234) to actions by the corresponding entities 244-246. For example, management apparatus 206 may use the cluster score for a cluster to output 208 a response to an action by an entity in the cluster. The response may include, but is not limited to, accepting the action (e.g., processing a purchase, creating an account, authenticating a user, transmitting a message, etc.), blocking the action (e.g., rejecting a purchase, account creation request, and/or authentication request), delaying the action, redirecting the action (e.g., to a different page or screen than the one requested in the action), and/or presenting a challenge (e.g., captcha challenge, two-factor authentication challenge, etc.) to the action. Management apparatus 206 may also, or instead, apply a blacklist and/or whitelist to the action and/or corresponding entity. The whitelist may allow entities 244-246 in the whitelist to carry out the requested actions, while the blacklist may block entities 244-246 in the blacklist from carrying the requested actions.

Management apparatus 206 may also monitor and/or aggregate outcomes 210 associated with output 208. For example, management apparatus 206 may track the rates at which each type of challenge is shown, submitted, or solved for a given type of action and/or location. In another example, management apparatus 206 may monitor, for a given type of action or response, the rate at which malicious activity is carried out or reported. In a third example, management apparatus 206 may determine, for each individual action, an outcome that specifies if the action resulted in malicious activity or non-malicious activity. Management apparatus 206 may update data repository 134 and/or another data store with individual or aggregated outcomes 210 and/or emit events containing outcomes 210 for subsequent processing and use by other components of the system. In turn, the updates may be used to update subsequent identification of malicious entities 244-246 and/or responses to actions by entities 244-246.

Analysis apparatus 204 may additionally include functionality to propagate attributes 240-242 associated with malicious entities 244-246 to other entities 244-246 and/or attributes 240-242.

First, analysis apparatus 204 may perform chaining (e.g., chaining 1 224, chaining y 226) of attributes 240-242 associated with individual entities or clusters of entities that were previously identified as malicious. During such chaining, analysis apparatus 204 may use an attribute associated with a cluster of malicious entities to identify additional attributes of the entities and use the additional attributes to further identify and/or generate one or more additional clusters of potentially malicious entities.

For example, analysis apparatus 204 may obtain a browser identifier from a cookie during an entity's session with the service. Analysis apparatus 204 may match the browser identifier and/or other attributes (e.g., attributes 240-242) of the entity to a cluster key (e.g., an attribute used to generate or define a cluster) for a cluster of entities that has been labeled as malicious. Analysis apparatus 204 may then obtain a set of other browser identifiers associated with the same entity and/or other entities in the cluster and identify a set of additional entities associated with the same browser identifier values (e.g., additional entities that have also accessed the service using the same browser identifier values) as potentially malicious.

In another example, analysis apparatus 204 may obtain the browser identifier and/or other attributes of an entity after the entity is independently flagged as malicious (e.g., based on actions of the entity during one or more sessions with the service). In response to the determination that the entity is malicious, analysis apparatus 204 may identify one or more other entities 244-246 with the same browser identifier as a cluster of potentially malicious entities. In other words, analysis apparatus 204 may “chain” attributes 240-242 of a potentially malicious entity to additional entities 244-246 that share some or all of the same attributes 240-242 and/or additional attributes 240-242 of the additional entities.

Second, analysis apparatus 204 may perform tainting (e.g., tainting 1 228, tainting z 230) of entities 244-246 identified as potentially malicious during the chaining process. During tainting of entities 244-246, analysis apparatus 204 may label new entities 244-246 as malicious and/or perform clustering and/or other analysis to determine if entities 244-246 are malicious or not.

For example, analysis apparatus 204 may obtain one or more attributes 240-242 that are chained or linked to clusters and/or entities that are labeled as malicious. Analysis apparatus 204 may then identify a subset of entities 244-246 with the attributes during access to the service by entities 244-246 (e.g., from information in requests received from entities 244-246 and/or profile data 216 for entities 244-246). In turn, analysis apparatus 204 may flag entities 244-246 as malicious or potentially malicious to trigger the prompt generation and/or output 208 of responses (e.g., responses 1 232, responses n 234) to actions of entities 244-246.

Analysis apparatus 204 may also perform multiple rounds of chaining and tainting using attributes 240-242 and the associated entities 244-246 to search for and identify additional clusters of potentially malicious entities 244-246. For example, analysis apparatus 204 may use a browser identifier associated with a malicious behavior to identify a set of entities with the browser identifier and obtain payment information (e.g., credit card numbers) for the entities. Analysis apparatus 204 may match the payment information to additional entities with the same payment information and flag the additional entities as potentially malicious (e.g., with or without analyzing features of the entities using one or more statistical models). Additional browser identifiers, payment information, and/or other attributes 240-242 that are strong indicators of malicious groups of entities may continue to be identified by chaining attributes 240-242 and tainting entities 244-246 associated with attributes 240-242 until all available attributes and/or entities associated with the initial browser identifier been explored.

During a given round of chaining and tainting 246, analysis apparatus 204 may use additional attributes 240-242 to determine if a given attribute or associated set of entities is sufficiently correlated with malicious behavior to qualify as a reliable indicator of the malicious behavior. For example, analysis apparatus 204 may obtain an IP address as an attribute that is chained from one or more malicious entities 244-246. Because the IP address may be used by other, non-malicious entities, analysis apparatus 204 may initially refrain from tainting all entities associated with the IP address as malicious. Instead, analysis apparatus 204 may form a cluster with the IP address as a cluster key and populate the cluster with other entities that have the same IP address. Analysis apparatus 204 may optionally filter entities in the cluster by other attributes 240-242 (e.g., browser identifier, email addresses, names, online scores, etc.) associated with the entities and/or form multiple clusters using the IP address and/or one or more other attributes 240-242. After a given cluster has reached a minimum size, analysis apparatus 204 may generate a cluster score from features 236-238 associated with entities in the cluster to determine if the cluster is malicious or not.

In another example, analysis apparatus 204 may aggregate the IP address with browser identifiers linked to malicious entities, patterns of names and/or email addresses that are indicative of malicious entities, and/or other attributes 240-242 that increase the likelihood of malicious behavior in the entities (e.g., after other entities with the same IP address access the service). After the aggregated attributes are linked to a threshold level of risk and/or include a certain number of attributes 240-242 that are associated with malicious entities, the IP address may be flagged as an attribute that indicates malicious behavior in entities 244-246.

Once entities 244-246 are initially identified or subsequently tainted as malicious, analysis apparatus 204 may select responses (e.g., responses 1 232, responses n 234) to actions by entities 244-246 based on scores 248-250 associated with entities 244-246. Scores 248-250 may include cluster scores produced during identification of malicious clusters. As mentioned above, clusters of entities may be associated with cluster scores generated by a statistical model and/or other technique. Each cluster score may represent the likelihood that the corresponding cluster of entities is malicious (e.g., having fake or hijacked accounts) and/or the severity or level of risk associated with malicious activity in the cluster.

Scores 248-250 may additionally include entity scores for individual entities that have been identified as malicious. For example, analysis apparatus 204 may calculate an entity score for an entity after the entity is identified as a member of a malicious cluster (e.g., during labeling of the cluster as malicious and/or subsequent access to the service by the entity). In another example, analysis apparatus 204 may calculate an entity score for the entity based on a pattern of actions conducted by the entity, independent of any clustering associated with the entity. To calculate an entity score, analysis apparatus 204 may apply a set of rules and/or another statistical model to an account age, reputation score, account type (e.g., paid account, unpaid account, etc.), number of confirmed email addresses, types of account verification, sequences of actions, IP addresses, and/or other attributes 240-242 for the corresponding entity. As a result, the entity score may represent the risk and/or likelihood of malicious behavior in the entity.

Analysis apparatus 204 may then use the entity score and/or cluster scores associated with a given entity to select one or more responses to the entity's actions or account with the service, and management apparatus 206 may generate output 208 to carry out the responses. For example, management apparatus 206 may output 208 a strong response (e.g., blocking the entity's access to the service) if the entity and/or cluster scores indicate a high likelihood of malicious behavior and/or associated risk. In another example, management apparatus 206 may output 208 a more moderate response (e.g., flagging the entity and/or the entity's actions for manual review) if the entity score indicates that the entity is moderately likely to engage in malicious behavior. In a third example, analysis apparatus 204 and/or management apparatus 206 may select and output 208 a response to the entity based on a weighted combination of the entity and cluster scores for the entity.

Finally, analysis apparatus 204 and/or management apparatus 206 may use a configuration 214 from data repository 134 and/or another data store to identify entities 244-246 and/or clusters of entities 244-246 as malicious, perform subsequent chaining and tainting of entities 244-246 and/or the associated attributes 240-242, and/or respond to actions of entities 244-246. For example, configuration 214 may specify features 236-238, an aggregation of features 236-238, and/or thresholds used to detect malicious clusters of entities 244-246; attributes 240-242 and thresholds used in chaining and tainting of entities 244-246; and/or responses to actions based on cluster and/or entity scores 248-250 for the corresponding entities. In another example, configuration 214 may include a blacklist of known malicious entities 244-246 and/or attributes 240-242 and/or a whitelist of known non-malicious entities 244-246 and/or attributes 240-242. In turn, management apparatus 206 may use the blacklist to automatically block access to the service for requests associated with the corresponding entities 244-246 and/or attributes 240-242 and the whitelist to automatically permit access to the service for requests associated with the corresponding entities 244-246 and/or attributes 240-242.

By efficiently identifying clusters of malicious entities 244-246 and propagating attributes 240-242 associated with malicious entities 244-246 to other entities 244-246, the system of FIG. 2 may perform both proactive and reactive assessment and management of malicious activity with the service. In turn, the system may detect and respond to malicious entities more quickly and thoroughly than anti-abuse infrastructures that do not perform clustering and/or propagation of attributes and/or entities that are tied to malicious behavior. Consequently, the system may improve technologies for preventing abuse in network-based services, as well as the execution, maintenance, and/or use of the network-based services on computer systems and electronic devices.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, different techniques may be used to perform clustering, chaining, and/or tainting associated with entities 244-246 of the service. For example, statistical models used to identify clusters of malicious entities and/or analyze individual entities may include artificial neural networks, Bayesian networks, support vector machines, clustering techniques, regression models, random forests, and/or other types or combinations of machine learning techniques. Similarly, configuration 214 may be specified using key-value pairs, JavaScript Object Notation (JSON) objects, Extensible Markup Language (XML) documents, property lists, database records, and/or other types of structured data.

Third, analysis apparatus 204, management apparatus 206, and/or other components of the system may execute in various contexts and/or environments. For example, statistical models used to identify clusters of malicious entities may be executed in an offline basis to flag existing entities as malicious and/or detect patterns in attributes 240-242 associated with malicious entities. In another example, analysis apparatus 204 and management apparatus 206 may score and respond to the entities in an online basis using limited data in requests and/or profile data 216 from the entities. In a third example, analysis apparatus 204 may operate on a nearline basis to score the entities as data is collected from the entities during use of the service by the entities. In turn, scoring of the entities may allow management apparatus 206 to generate responses to the entities' actions in a timely manner while enabling the entities' intentions and/or actions to be more accurately assessed using a larger amount of data.

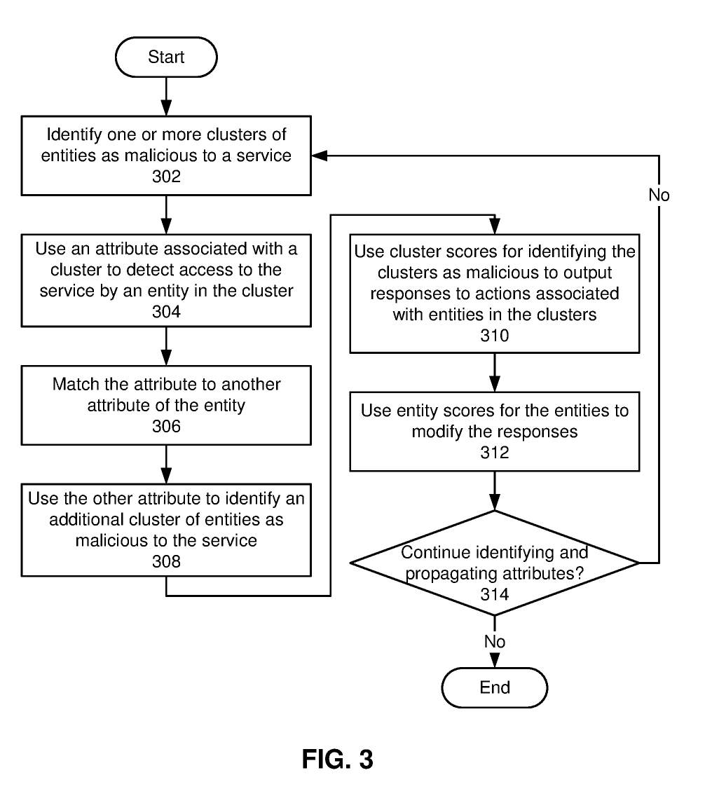

FIG. 3 shows a flowchart illustrating the processing of actions with a service in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, one or more clusters of entities are identified as malicious to a service (operation 302). For example, a clustering technique and/or statistical model may be applied to a set of features associated with the entities to generate one or more cluster scores representing the likelihood that the corresponding cluster(s) of entities are malicious to the service. The features may include raw features (e.g., attributes) of the entities and/or aggregations of the raw features into distribution features, pattern features, and/or frequency features. One or more thresholds may be applied to the cluster scores to classify the entities as malicious or non-malicious and/or establish various levels of risk or severity associated with malicious behavior in the cluster.

Next, an attribute associated with a cluster is used to detect access to the service by an entity in the cluster (operation 304). For example, the attribute may be a cluster key that is used to define and/or generate the cluster. When the entity accesses the service, the attribute may be obtained from a request and/or other data associated with the entity and matched to another attribute of the entity (operation 306). For example, a browser identifier from a cookie for the entity may be used as a cluster key that identifies the entity as a member of a cluster of malicious entities. An entity identifier that uniquely identifies the entity may be obtained from the same cookie and/or a request associated with the cookie, and the entity identifier may be used to retrieve profile data for the entity (e.g., username, first name, last name, email address, profile photo, etc.), payment information associated with the entity, the entity's IP address and/or user agent, and/or other attributes of the entity.

The other attribute is used to identify an additional cluster of entities as malicious to the service (operation 308). For example, a set of entities containing the same payment information as the entity may be obtained and included in the additional cluster (e.g., as the entities access the service and/or based on stored payment information for the entities). One or more additional attributes may further be used to establish the second cluster of entities as malicious. For example, entities in the second cluster may be filtered based the additional attribute(s). In another example, the additional attributes may be inputted with the other attribute into a statistical model that determines if the additional cluster is malicious or non-malicious.

Cluster scores for identifying one or both clusters as malicious are then used to output responses to actions associated with entities in the cluster (operation 310), and entity scores for the entities are used to modify the responses (operation 312). For example, the cluster scores may be outputted in operations 302 and/or 308, and entity scores representing the risk and/or likelihood of malicious behavior in individual entities may be calculated for entities in the clusters. The cluster scores and/or entity scores may then be used to generate responses such as whitelisting or blacklisting an entity; accepting, blocking, delaying, and/or redirecting an action; flagging an entity or action for manual review; and/or presenting a challenge related to an action.

Attributes may continue to be identified and propagated (operation 314) across entities and/or clusters of entities. For example, operations 302-312 may be repeated to perform chaining and/or tainting across multiple attributes, entities, and/or clusters of entities until all entities and/or attributes linked to entities that have previously been flagged as malicious have been explored and/or analyzed for potentially malicious behavior.

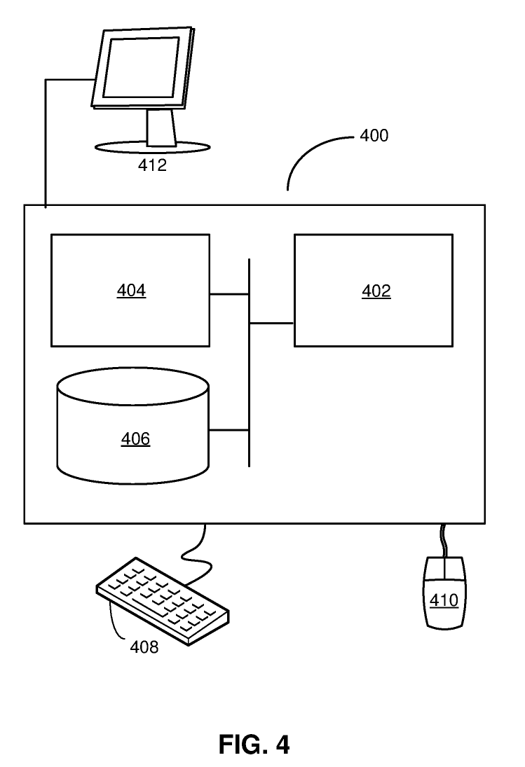

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412. Computer system 400 may also, or instead, include components of a portable electronic device, such as a touchscreen, camera, fingerprint sensor, and/or one or more inertial sensors.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing user actions with a service. The system may include an analysis apparatus and a management apparatus, one or both of which may alternatively be termed or implemented as a module, mechanism, or other type of system component. The analysis apparatus may obtain a first attribute associated with a first cluster of entities identified as malicious to a service. Next, the analysis apparatus may match the first attribute to a second attribute of an entity in the first cluster. The analysis apparatus may then use the second attribute to identify a second cluster of entities as malicious to the service. Finally, the management apparatus may use cluster scores for identifying the first and second clusters of entities as malicious to the service to output responses to actions associated with entities in the first and second clusters of entities.

In addition, one or more components of computer system 400 may be remotely located and connected to the other components over a network. Portions of the present embodiments (e.g., analysis apparatus, management apparatus, data repository, online professional network, service, etc.) may also be located on different nodes of a distributed system that implements the embodiments. For example, the present embodiments may be implemented using a cloud computing system that provides an anti-abuse infrastructure for detecting and managing malicious activity associated with a set of remote users and/or entities.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a first attribute associated with a first cluster of entities identified as malicious to a service;
matching, by one or more computer systems, the first attribute to a second attribute of an entity in the first cluster;
using the second attribute to identify, by the one or more computer systems, a second cluster of entities as malicious to the service; and
using cluster scores for identifying the first and second clusters of entities as malicious to the service to output responses to actions associated with entities in the first and second clusters of entities.

2. The method of claim 1, further comprising:
using a set of features associated with attributes of the entities to identify the first cluster of entities as malicious to the service.

3. The method of claim 2, wherein using the set of features to identify the first cluster of entities as malicious to the service comprises:
applying a statistical model to the set of features; and
obtaining, as output from the statistical model, a cluster score representing a likelihood that the first cluster of entities is malicious to the service.

4. The method of claim 2, wherein the set of features comprises at least one of:
a distribution feature;
a pattern feature; and
a frequency feature.

5. The method of claim 1, further comprising:
using a set of entity scores for the entities in the first and second clusters to modify the responses.

6. The method of claim 1, further comprising:
matching the second attribute to a third attribute of an entity in the second cluster; and
using the third attribute to identity a third cluster of entities as malicious to the service.

7. The method of claim 1, wherein obtaining the first attribute associated with the first cluster of entities identified as malicious to the service comprises:
using the first attribute to detect access to the service by the entity in the first cluster.

8. The method of claim 1, wherein using the second attribute to identify the second cluster of entities as malicious to the service comprises:
obtaining a set of entities containing the second attribute; and
including the set of entities in the second cluster.

9. The method of claim 8, wherein using the second attribute to identify the second cluster of entities as malicious to the service further comprises:
using one or more additional attributes to identify the second cluster of entities as malicious to the service.

10. The method of claim 1, wherein the first and second attributes comprise at least one of:
a cookie;
a network address;
an account identifier;
a profile attribute;
a registration date;
a user agent; and
payment information.

11. The method of claim 1, wherein the responses comprise at least one of:
whitelisting an entity;
blacklisting the entity;
accepting an action;
blocking the action;
delaying the action;
flagging the action for manual review;
redirecting the action; and
presenting a challenge related to the action.

12. The method of claim 1, wherein the entities comprise user accounts with the service.

13. A system, comprising:
one or more processors; and
memory storing instructions that, when executed by the one or more processors, cause the apparatus to:
obtain a first attribute associated with a first cluster of entities identified as malicious to a service;
match the first attribute to a second attribute of an entity in the first cluster;
use the second attribute to identify a second cluster of entities as malicious to the service; and
use cluster scores for identifying the first and second clusters of entities as malicious to the service to output responses to actions associated with entities in the first and second clusters of entities.

14. The system of claim 13, wherein the memory further stores instructions that, when executed by the one or more processors, cause the apparatus to:
use a set of features associated with attributes of the entities to identify the first cluster of entities as malicious to the service.

15. The system of claim 14, wherein using the set of features to identify the first cluster of entities as malicious to the service comprises:
applying a statistical model to the set of features; and
obtaining, as output from the statistical model, a cluster score representing a likelihood that the first cluster of entities is malicious to the service.

16. The system of claim 15, wherein the set of features comprises at least one of:
a distribution feature;
a pattern feature; and
a frequency feature.

17. The system of claim 13, wherein using the second attribute to identify the second cluster of entities as malicious to the service comprises:
obtaining a set of entities containing the second attribute; and
including the set of entities in the second cluster.

18. The system of claim 17, wherein using the second attribute to identify the second cluster of entities as malicious to the service further comprises:
using one or more additional attributes to identify the second cluster of entities as malicious to the service.

19. The system of claim 13, wherein the first and second attributes comprise at least one of:
a cookie;
a network address;
an account identifier;
a profile attribute;
a registration date;
a user agent; and
payment information.

20. A non-transitory computer-readable storage medium storing instructions that when executed by a computer cause the computer to perform a method, the method comprising:
obtaining a first attribute associated with a first cluster of entities identified as malicious to a service;
matching the first attribute to a second attribute of an entity in the first cluster;
using the second attribute to identify a second cluster of entities as malicious to the service; and
using cluster scores for identifying the first and second clusters of entities as malicious to the service to output responses to actions associated with entities in the first and second clusters of entities.
